(19) United States
(12) Patent Application Publication
(10) Pub. No.: US 2004/0039923 A1
(43) Pub. Date: Feb. 26, 2004

(54) System and method for distributing data

(76) Inventor: Steven James Joseph Koskins, Amsterdam (NL)

Correspondence Address: Bereskin & Parr, Box 401, 40 King Street West, Toronto, ON, M5H 3Y2, CA

(21) Appl. No.: 10/297,919

(22) PCT Filed: Jun. 19, 2001
(86) PCT No.: PCT/CA01/00889

(30) Foreign Application Priority Data
Jun. 20, 2000 (US) 60212684

(51) Int. Cl. H04L 9/00; H04L 9/32

(52) U.S. Cl. 713/189; 380/277; 713/150; 713/202; 705/51

(57) ABSTRACT

A system for distributing data includes a volume of encrypted data distributed with activation and decryption software ware. The volume is provided to a user so that is locally accessible on the user's computer. A decryption key which allows encrypted data to be decrypted by accessing a distribution control web site and providing a username and password. The decryption key may be operable only for a part of the encrypted data and may be operable only for a selected period. While the decryption is operable on one computer, a decryption key is not provided to a second computer utilizing the same username and password method for using the system is also disclosed.

### FIELD OF THE INVENTION

This invention relates to a system and method for distributing data. More particularly, the invention relates to a system and method for distributing encrypted data (or software) and authorizing the decryption of the data using the Internet.

### BACKGROUND OF THE INVENTION

The world wide web, and more generally the Internet, have become primary means for distributing data and computer software. Data files containing still images and/or video graphics are generally very large. Most users do not have an Internet connection with sufficient bandwidth to allow for rapid delivery of such data files.

Web sites designed to distribute still images or videos will generally display a “thumbnail” image each still image or a sample frame from each video graphic. The user may click on a thumbnail to see the entire still image or on a sample frame to see the video graphic. In general, still images, especially larger images with a high resolution, are typically displayed after a delay of at least a few seconds. Video images cannot practically be displayed in real time over the Internet, except at a very low resolution. As a result, the user may be forced a substantial period (even up to several hours) to view a complete high resolution video.

Although it is possible to simply deliver this type of data to users on a CD-ROM or other mass storage medium, this has the disadvantage that users may duplicate the CD-ROM and distribute copies of it, thereby circumventing the ability of the distributor of the data to earn income from all sales of his data.

Accordingly, there is a need for a system and method for rapidly distributing large data files, including still images and videos, to a user's computer, while still allowing the distributor to control the distribution of the data and to obtain revenue from such distribution.

### SUMMARY OF THE INVENTION

In one aspect the present invention provides a system for distributing data comprising: a volume including encrypted data, activation software and decryption software; a computer having means for locally accessing said encrypted data and for executing said activation software and said decryption software; a distribution control web site for controlling decryption of said encrypted data; and a network for operationally coupling said computer and said distribution control web site, wherein said activation software is configured to receive a decryption key from said distribution control web site across said network and wherein said decryption software is configured to decrypt said encrypted data so that it is accessible by said computer in a decrypted form.

In a second aspect, the present invention provides a method of distributing data comprising the steps of: distributing a volume containing encrypted data; providing a decryption key, over a network, to a computer having means for locally accessing said encrypted data; and decrypting said encrypted software using said decrypting key such that it is locally accessible from said computer.

### BRIEF DESCRIPTION OF THE DRAWINGS

The present invention will now be explained by way of example only, with reference to the drawing in which:

FIG. 1 illustrates a system for distributing data according to the present invention;

FIGS. 2a and 2b illustrate a method according to the present invention; and

FIG. 3 illustrates an authorization period and a blackout period of the method of FIGS. 2a and 2b.

### DETAILED DESCRIPTION OF THE PREFERRED EMBODIMENT

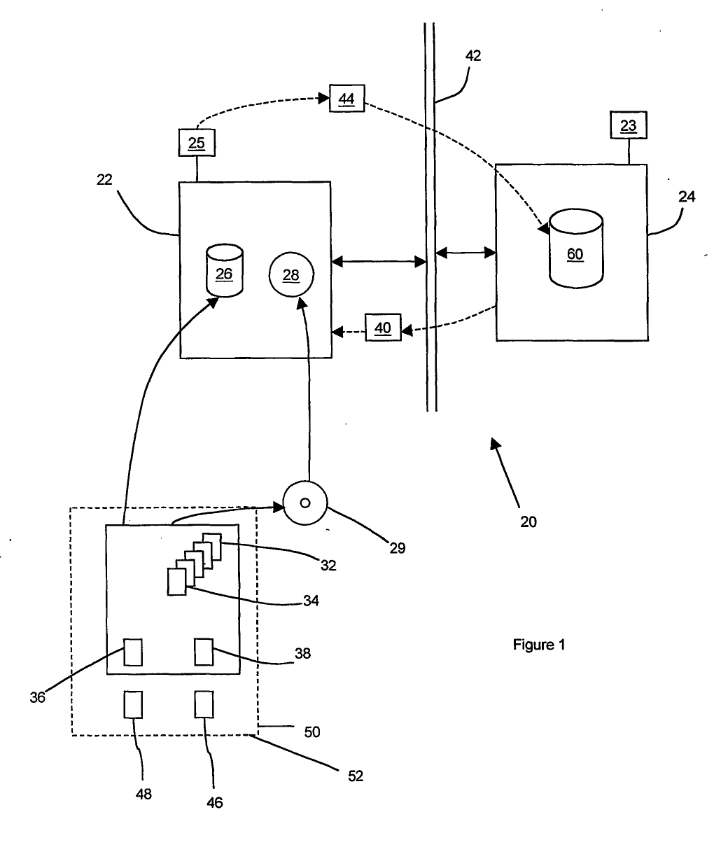

Reference is first made to FIG. 1, which illustrates a system 20 for distributing data. System 20 comprises a user's computer 22 and a data distribution control web site 24. Computer 22 may have a number of data storage and retrieval means, including a hard disc drive 26 and a CD-ROM drive 28. A volume 30, which may be recorded on hard disc drive 26 or a CD-ROM 29 inserted into CD-ROM drive 28, is accessible on computer 22. Volume 30 may be any type of storage device, such a floppy disc, a hard disc or a CD-ROM or may be a directory or folder on any type of storage device or any other means for storing data. Volume 30 contains encrypted data 32, which may be divided into blocks 34. Volume 30 also contains activation software 36 and decryption software 38, which may be used to view and decrypt the encrypted data 32.

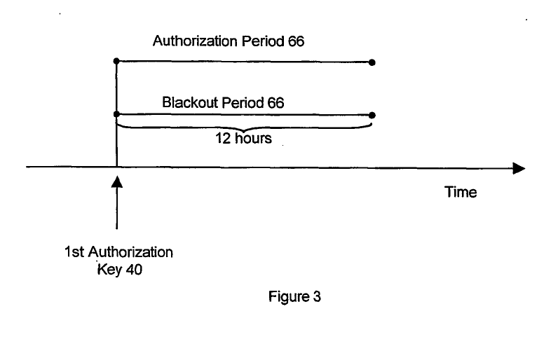

Data distribution control web site 24 is operated by a distributor 23 of encrypted data 32. Computer 22 may be connected to web site 24 via the internet 42 or another network. Activation software 36 may obtain a decryption key 40 from web site 24. Decryption program 38 may decrypt some or all of the encrypted data using decryption key 40. Decryption key 40 may be configured to allow decryption of some or all of the encrypted data 32 and may be configured to expire after a selected authorization period 68 (FIG. 3). Also, decryption key 40 may be configured to operate only on computer 22.

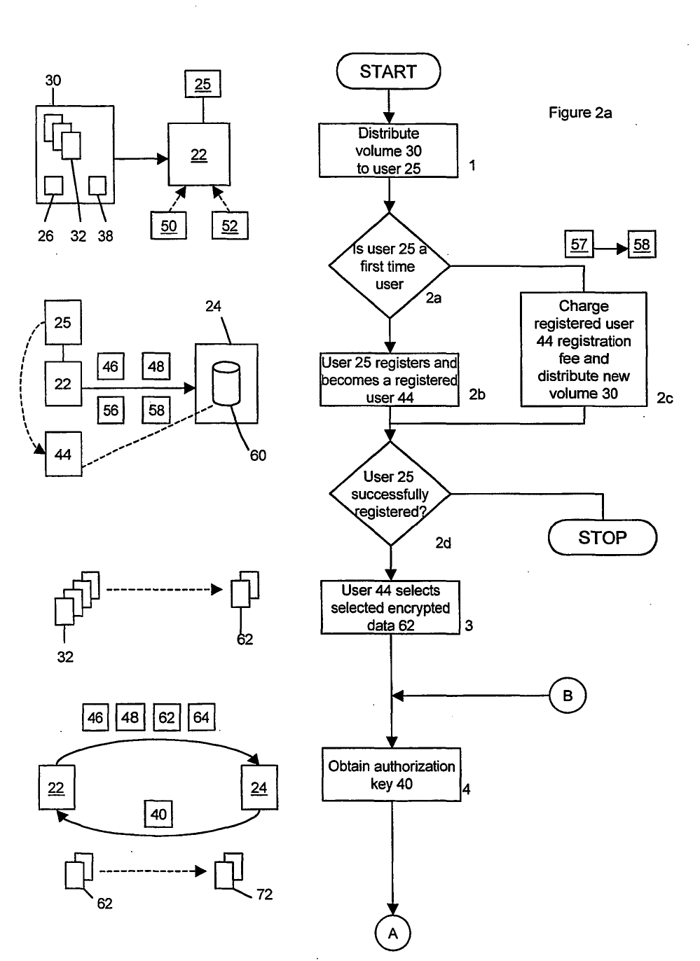

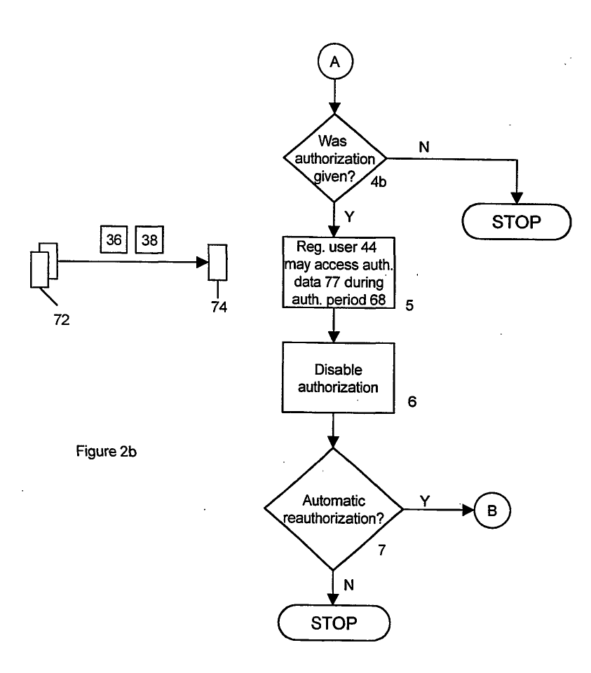

A method according to the present invention will now be explained with reference to FIGS. 2a and 2b.

Step 1—Distribution of Volume 30

In step 1 of the present method, volume 30 of encrypted data 32 is distributed to a user 25 so that it may be accessed locally by a user's computer 22. In addition to the encrypted data 32, volume 30 contains activation software 36 and decryption software 38. Decryption software 38 requires a decryption key 40, which is not provided with the volume, to decrypt the encrypted data.

Encrypted data 32 may be distributed to user 25 by any conventional means. For example, encrypted data 32 may be distributed to user 25 on CD-ROM 29 or other storage means, or by transmission over the Internet 42 or another network and stored on the hard drive 26 of the user's computer 22. Any other method which provides user 25 with a locally accessible copy of volume 30 may be used.

All or some of the encrypted data 32 may grouped into blocks 32. The activation software 36 may allow user 25 to review an index (i.e. a table of contents) of the encrypted data 32 in volume 30 and may allow user 25 to select all or part of the encrypted data 32 for viewing, as described below.

In order view encrypted data 32, user 25 must be a registered user 44 of web site 24. If the user 25 has been previously registered, the distributor may distribute only the volume 30 to the user 25. If the user 25 is not a registered user 44, then a username 46 and password 48 are distributed to the user 25 along with volume 30.

Typically, a first time user 25 will obtain volume 30 by: (a) purchasing a package 50 containing CD-ROM 29 and a password 46 and username 48; or by (ii) downloading a data file 52 containing volume 30 and a username 46 and password 48. The username 46 and password 48 combination delivered to any user 25 is unique.

A registered user 44 will typically obtain volume 30 through the mail by pre-arrangement with distributor 23 or by downloading it from web site 24. Distributor 23 may distribute a new volume 30 to all registered users periodically. Each new volume 30 will remain current for a selected period (i.e. a month).

A user 25 who was previously registered but whose registration has ended without being renewed in accordance with step 2c is considered to be a first time user 25 and not a registered user 44.

Step 2—Registration of First User 25 or Re-registration of an Existing Registered User 44

Step 2a—Decide whether user 25 is a First Time User or a Registered User 44

If user 25 is a first time user, then user 25 will register with web site in accordance with step 2b. If user 25 is a registered user 44, then he will be re-registered in accordance with step 2d.

Step 2b—User Registration for a First Time user 25

After a first time user 25 has obtained a username and password in accordance with step 1, the first time user 25 may become a registered user 44 by connecting with web site 24 and accessing a user registration page 54. User registration page 54 allows the first time user 25 to enter his username 46, password 48 and identification information 56 about himself. In addition, the first time user 25 may enter payment information 58 which may be subsequently be used to authorize decrypting of the encrypted data 32 in volume 30.

The data entered by the first time user is validated to ensure that:

(i) username 46 is unique (i.e it has not been used by another user 25) and password 48 is valid for use with username 46 (ii) the identification information 56 appears to be accurate and complete, and does not appear to identify a user 25 who is not permitted to use the distribution control web site 24 (for example, a user 25 who has previously abused the distribution control web site 24); and

(iii) the payment information 58 is acceptable and valid (i.e. a proper billing method (i.e. credit card, on-line check or any other type of known payment which may be used on-line) is identified and is the information is valid (i.e. a credit card is not expired)).

If all of the data is valid, then the first time user 25 is added to a registered user database 60 maintained by distribution control web site 24, and the first time user 25 becomes a registered user 44 and has an active account on web site 24. The user 25 will remain a registered user 44 for a selected registration period (i.e. a month). In a different embodiment of a method distributing data according to the present invention, the user may remain a registered user indefinitely.

The registered user 44 may or may not be charged a registration fee 57 at the time he is registered as a user of web site 24. In the preferred embodiment, no such charge is made, and the new registered user 44 is able to access all the encrypted data 32 in volume 30 during the registration period, without paying any additional fee above that paid to obtain volume 30. In a different embodiment, distributor 23 may charge a registration or other fee to the newly registered user 44 using payment information 58.

A previously registered user 44 will not perform this step, but will be automatically re-registered periodically according to step 2b.

Step 2c—Registration of a Previously Registered User 44

As noted above, a new volume 30 is distributed to every registered user 44 periodically (i.e. monthly), either by allowing registered user 44 to download it from web site 24 or by delivering it on a CD-ROM to the registered user 44. Prior to distributing the new volume 30 to the registered user 44, a registration fee 57 covering a new registration period is charged to the registered user 44 using the payment information 58 provided by registered user 44 when he became a registered user 44. If distributor 23 is unable to charge the registration fee 57 to registered user 44, the user's registration with web site 24 is cancelled and the user account is made inactive.

Step 2d—Ensure That Registration was Successful

If user 25 was successfully registered as a new registered user 44 in step 2b, or was successfully re-registered as an existing registered user 44 in step 2c, the method proceeds to step 3. Otherwise it ends.

Step 3—Selection of the Data the User Wishes to Review

A registered user 44 may use the activation software 36 provided with volume 30 to view an index of the encrypted data 32. The listing may be a text list, or it may be a graphical display which gives an indication of the type of each piece of encrypted data 32. For example, if encrypted data 32 comprises still images, then the index may comprise a thumbnail of each still image. If encrypted data 32 comprises video movies, then the index may comprise a description of the movie or a frame from the movie. A single entry in the index may be used to represent a block 34 of encrypted data 32.

The registered user 44 may select one or more items in the index. The items of encrypted data selected by the registered user 44 are referred to as selected encrypted data 62. When the registered user 44 has selected all of the encrypted data 32 that he wishes to access, the registered user 44 indicates that he would like to obtain authorization to access the selected encrypted data 62.

Step 4—Authorize Access to s I cted Encrypted Data

Activation software 36 establishes a connection with data distribution control web site 24. Activation software 36 passes the following information to web site 24:

(i) username 46 and password 48 of registered user 44;

(ii) a hardware identifier 64; and

(iii) a list of the selected encrypted data 62.

Hardware identifier 64 is calculated by activation software 36 based on information which is likely to be unique to computer 22. For example, hardware identifier 64 may calculated based on the serial number of computer 22, the serial number of the BIOS of the computer 22 or other information.

Activation software 36 may request the registered user's username 46 and password 48 each time an authorization attempt is made according this step by displaying a dialog box, or may obtain it from a locally stored data file. In the preferred embodiment, a registered user's username 46 and password 48 are not permanently recorded on the registered user's computer in order to prevent an unauthorized person from using the registered user's registration. However, the registered user's username 46 and password 48 are recorded temporarily when the registered user enters them for the first time in each session of activation software 36. The username 46 and 48 are stored until that session of activation software 36 ends, and activation software 38 may use this stored data so that the registered user 44 is required to enter is username 46 and password only once per session.

Web site 24 evaluates this information to ensure that:

(i) the username 46 and password 48 are valid and belong to a registered user who has a currently active account;

(ii) the username 46 and password 48 have not been used to authorize access to any encrypted data 32 from any computer other than computer with a hardware identifier other than hardware identifier 64 during a selected period (the blackout period 66) immediately preceding the present attempt to obtain authorization.

The second condition is imposed to reduce the chance that a single username 46 and password 48 may be used to obtain simultaneous authorization for access to encrypted data 32 from two different computers. If the username 46 and password 48 have been used to obtain authorization during a black out period 66, then the present authorization is refused (Step 4b).

If both conditions are met, web site 24 transmits a decryption key 40 to activation software 36. When decryption key 40 is transmitted, an associated authorization period 68 and blackout period 66 begin. Decryption key 40 is coded to permit decryption of the selected encrypted data 62 only during the associated authorization period 68 and only at computer 22. The selected encrypted data is then considered authorized data 72.

Reference is made to FIG. 3. In the preferred embodiment, the authorization period 68 and blackout period 66 are equal and are set at 12 hours. As a result, a registered user 44 who obtains authorization to access authorized data 72 from computer 22 may access that authorized data 72 for 12 hours (the authorization period), but may not obtain access to any encrypted data 32, including the authorized data 72, from any other computer for 12 hours (the blackout period). This will reduce the chance that a registered user 44 will share his account with an unregistered user 25, since the registered user 44 will not be able to utilize his account for 12 hours after the unregistered user 25 has used the account to obtain authorization to access any encrypted information.

Step 5—Allow User to Access Data for Authorization Period

In this step, registered user 44 is permitted to access authorized data 72 during the authorization period. Using activation software 36, registered user 44 may select any particular authorized data 72. Activation software 36 invokes decryption software 38, which utilizes decryption key 40 to decrypt the particular authorized data 72 to create a decrypted data file 74. Activation software 36 then allows registered user 44 to access decrypted data file 74. This may be done, for example, by opening a window to display decrypted data file 74. When registered user 44 closes the window, decrypted data file 74 is destroyed. In this way, registered user 44 may access any of the authorized data 72 any number of times during the authorization period 68.

If registered user 44 attempts to access encrypted data 32 other than authorized data 72, several actions may be taken. The attempt may be rejected and an appropriate message may be displayed reminding registered 44 that he must obtain authorization to access encrypted data 32 before activation software 36 will permit him to access it. Alternatively, activation software 32 may be configured to carry out step 4 automatically in respect of the particular encrypted data 32 that registered user 44 has attempted to access.

In the preferred embodiment, activation software 32 is configured to automatically obtain authorization to access the particular encrypted data 32 by carrying out step 4. When registered user 44 attempts to access the particular encrypted data, activation software 36 initially discards the existing decryption key 40 (with the result that all of the authorized data 72 is no longer authorized). It then requests authorization for all of the previous authorized data as well as the particular encrypted data. While activation software 36 is communicating with web site 24 to do so, a message may be displayed to registered user 44 indicating that authorization is being obtained. If web site 24 authorizes access to the particular encrypted data 32, it will transmit a new decryption key 40, which is encoded to permit decryption of the particular encrypted data 32, in addition to any previously authorized data 72. To the registered user 44, it will appear as though the particular encrypted data 32 has been added to the set of authorized data 72. The new decryption key will permit decryption of any authorized data 72. The authorization period of the new decryption key 40 will begin from the time it is issued, and a new blackout period will begin to prevent the use of the registered username and password from another computer for the time of the blackout period.

In this way, the registered user 44 is able to access any encrypted data 32 during the authorization period 68 of the most recently decryption key 40.

Step 6—Disable Authorization

When the authorization period 68 of the most recently obtained decryption key 40 expires (i.e. all authorization, the decryption key 40 can no longer be used to decrypt any of the encrypted data 32. The registered user 44 may obtain a new decryption key in accordance with steps 3 and 4.

Activation software 36 may be configured to terminate the authorization period of a decryption key 40 prematurely if one or more selected events occurs.

For example, in the preferred embodiment, activation software 36 may record decryption key 40 only in the memory of computer 22. As a result if computer 22 is turned off or stops operating for any reason and must be reset, the decryption key 40 will be lost, effectively ending its authorization period 68.

Activation software 36 may be configured to discard decryption key 40 if the execution of activation software 36 is terminated. If registered user 44 terminates his session of activation software 36, the authorization period 68 of any decryption key 40 obtained during that session will end. Note that this will not end the blackout period 66 which began when the decryption key 40 was obtained.

Additionally, activation software 36 may be configured to terminate the authorization period 68 of a decryption key 40 on request from web site 24. If web site 24 receives a request to authorize access to encrypted data 32 from a computer other than computer 22 (i.e. a computer with a different hardware identifier) during the black out period of decryption key 40, web site 24 will deny the request and may transmit a “Terminate authorization period” message to activation software 36. Upon receiving this message activation software 36 will discard its previously obtained decryption key 40, thereby ending authorization period 68. Web site 24 may be configured to refuse further attempt to obtain authorization to access to encrypted 32 from any computer, including computer 22, either indefinitely or for a selected period.

In the preferred embodiment, activation software 36 is configured to terminate authorization period 68 and discard decryption key 40 in all three of these conditions.

Step 7—Allow Reauthorization—for New Authorization Period

Activation software 36 may be configured to automatically attempt to renew the authorization of registered user 44 to access authorized data 72 if authorization period 68 expires while activation software 36 is still executing. Activation software 36 may communicate with web site 24 to obtain a new decryption key 40. This will commence a new authorization period 68 associated with the new decryption key 40, and will commence a new blackout period 68.

Alternatively, when activation period 68 expires, activation software 36 may simply discard decryption key 40, and then allow registered user 44 to return to step 3.

Discussion of Preferred Embodiment

The preferred embodiment of the present invention, as described above, allows a user to access data on a locally stored volume. Since the data is locally stored, it is made available (i.e. displayed) much more quickly than would be possible in the data was to be transmitted over the Internet. At the same time, the system and method allow the distributor to control the distribution of the data and to collect revenue from each person who accesses the data.

The use of an authorization period and a blackout period helps to reduce use of a single username and password combination by more than one user. The selection of the specific authorization period and blackout period, which need not be identical will be within the competence of a person skilled in the art.

Additional Features

Different embodiments of a system and method according to the present invention may have other features than the preferred embodiment described above.

One such embodiment may have include a mechanism for logging the number of times a registered user 44 accesses any particular piece of authorized data 72 during step 5. This information may be transmitted to web site 24 either concurrently or it may be collected and later transmitted to web site 24. Such information would allow distributor 23 to make royalty payments for distribution of copyrighted material and to track the demand for particular pieces or types of data.

In another embodiment, the method may allow registration of new users for free and for re-registration of existing registered users for free in step 2. In such an embodiment, distributor 23 may charge a registered user for each piece of information for which he obtains authorization in accordance with step 4. In this way, a user is required to pay only for the data that he wishes to access.

In another embodiment, the method may allow for access to volumes which were issued during previous registration periods. In such a system, the activation program and decryption program issued with a current volume would be capable of decrypting and displaying encrypted data from a previous volume, if the appropriate decryption key is available. An appropriate decryption key may be available from web site 24. A user who was a registered user when the previous volume was current, and who paid for access to certain encrypted data on the previous volume may be able to obtain a decryption key for that volume for free. Alternatively, such free access may be limited to a registered who has continuously maintained a current registration since that previous volume was current. Other users may be able to pay for such a decryption key. In such an embodiment, the activation program may be configured to allow the user to combine various pieces of authorized data from different volumes to produce a collection of data of the user's choice. For example, video clips from different volumes may be combined to make a movie.

Another embodiment of the present invention may be configured with relatively short authentication and blackout periods. The preferred embodiment of the present invention sets both of these periods 12 hours. This has the advantage that a registered user may access authorized data for up to 12 hours without having to obtain re-authorization. However, it has the disadvantage that the registered user must do so from the same computer at which he received the authorization, since another computer cannot receive a decryption key during the blackout period. This problem could be resolved by reducing the blackout period, but this would open the possibility of the same username/password being used to obtain access simultaneously from two different computers. A better solution is to reduce both the authorization period and blackout period equally. If both are reduced to 10 minutes, then an registered user may obtain authorization to access encrypted data at another computer only 10 minutes after obtaining access at a first computer. However, this forces the registered user to obtain a new authorization every 10 minutes, effectively forcing him to remain connected to the distribution control web site. A person skilled in the art will be capable of selecting appropriate authorization and blackout periods.

In another embodiment of the present invention, a facility may be provided to obtain authorization from a second computer during a blackout period which began when an authorization was obtained from a first computer. In such a system, when the second authorization attempt is made, a registered may be able to transmit a “knockout code” to the distribution control web site. The knockout code which will be a special code which is associated with the registered user's username. If the distribution control web site receives an appropriate knockout code from the user, it will attempt to contact the activation program executing on the first program and instruct that activation program to discard its decryption key, thereby disabling any access to encrypted data from that computer. If distribution control web site is able to make such a connect and the activation program executing of the first computer confirms that it has successfully discarded its decryption key, then the distribution control web site may authorize access from the second computer by providing a decryption key to an activation program executing on it.

In another embodiment according to the present invention, the distributor may distribute volume 30 at no charge. Such free distributions may permit a user to become a registered user for a short selected period, after which the registered user may maintain his registration for future periods, possibly for a registration fee,

These and other variations of the present invention will be within the skill of a person skilled in the art, and fall within the spirit and scope of the invention, which is limited only by the following claims.

I claim:

1. A system for distributing data comprising:
(a) a volume including encrypted data, activation software and decryption software;
(b) a computer having means for locally accessing said encrypted data and for executing said activation software and said decryption software
(c) a distribution control web site for controlling decryption of said encrypted data;
(d) a network for operationally coupling said computer and said distribution control web site,
wherein said activation software is configured to receive a decryption key from said distribution control web site across said network and wherein said decryption software is configured to decrypt said encrypted data so that it is accessible by said computer in a decrypted form.

2. The system of claim 1 wherein said decryption key is operable to decrypt some but not all of said encrypted data.

3. The system of claim 1 wherein said decryption key is operable only for a selected period.

4. A method of distributing data comprising the steps of:
(a) distributing a volume containing encrypted data;
(b) providing a decryption key, over a network, to a computer having means for locally accessing said encrypted data;
(c) decrypting said encrypted software using said decrypting key such that it is locally accessible from said computer;

5. The method of claim 4 wherein said decryption key is operable to decrypt only some of said encrypted data.

6. The method of claim 4 wherein said decryption key is operable only for a selected period and wherein step (d) terminates after said selected period.

7. The method of claim 6 wherein a password must be specified before step (b), and wherein another decryption key will not be provided during step (c) unless a different password is entered.

8. A system for distributing data substantially as described herein.

9. A method of distributing data substantially as described herein.
